(19) United States
(12) Patent Application Publication
(10) Pub. No.: US 2026/0066708 A1
(43) Pub. Date: Mar. 5, 2026

(54) POWER RECEIVER APPARATUS, POWER TRANSFER APPARATUS, AND WIRELESS POWER TRANSFER SYSTEM

(71) Applicant: KABUSHIKI KAISHA TOSHIBA, Kawasaki-shi (JP)

(72) Inventors: Yukako TSUTSUMI, Kawasaki Kanagawa (JP); Toshiya MITOMO, Yokohama Kanagawa (JP); Kazuki ARAI, Yokohama Kanagawa (JP)

(73) Assignee: KABUSHIKI KAISHA TOSHIBA, Kawasaki-shi (JP)

(21) Appl. No.: 19/302,002

(22) Filed: Aug. 17, 2025

(30) Foreign Application Priority Data
Sep. 2, 2024 (JP) 2024-150846

(51) Int. Cl. H02J 50/20; H01Q 1/24; H02J 50/40; H02J 50/80; H02J 50/90

(52) U.S. Cl. CPC H02J 50/20; H01Q 1/24; H02J 50/402; H02J 50/80; H02J 50/90

(57) ABSTRACT

A power receiver apparatus includes an antenna unit, a power reception circuit, a rectifier circuit, and a transmission circuit. The antenna unit includes, on a first face, one or more first antennas that receive radio waves from an outside, and two or more second antennas that transmit the radio waves to the outside. The power reception circuit is connected to the first antennas, and receives a power signal via the one or more first antennas. The rectifier circuit rectifies the power signal received by the power reception circuit. The transmission circuit is connected to the second antennas, and transmits a wireless signal via the second antennas. The first face of the antenna unit includes a first region, and a second region that is at least a portion of a region surrounding the first region, and the second antennas are present in the second region.

### CROSS REFERENCE TO RELATED APPLICATIONS

This application is based upon and claims the benefit of priority from Japanese Patent Application No. 2024-150846, filed on Sep. 2, 2024, the entire contents of which are incorporated herein by reference.

### FIELD

Embodiments described herein relate generally to a power receiver apparatus, a power transfer apparatus, and a wireless power transfer system.

### BACKGROUND

According to the development of electrical products, a wireless power transfer technology that enables charging without a physical interface such as a charging pad or a plug has been widely developed and studied. As an example of wireless power transfer, a technique using microwaves has been proposed. In this implementation, a power transmitter including a microwave array emitter estimates a position where a beacon signal has been transmitted from a beacon device, and transmits power.

Therefore, power transmission from the transmitter is concentrated on a position where the beacon signal is transmitted in a receiver. A rectenna in a device to be charged receives and rectifies microwave energy, and uses the microwave energy to charge a battery and/or uses the microwave energy as main power. However, in this technique, a position of a beacon transmission antenna or a position to which power will be transmitted from among a plurality of antenna elements that receives power has not been sufficiently discussed, and there is a problem in which power to be received is small.

### BRIEF DESCRIPTION OF DRAWINGS

FIG. 1 is a diagram schematically illustrating a wireless power transfer system according to an embodiment;

FIG. 2 is a block diagram schematically illustrating a power receiver apparatus according to an embodiment;

FIG. 3 is a diagram illustrating an example of arrangement of antennas in an antenna array according to an embodiment;

FIG. 4 is a diagram illustrating an example of arrangement of antennas in an antenna array according to an embodiment;

FIG. 5 is a diagram illustrating an example of arrangement of antennas in an antenna array according to an embodiment;

FIG. 6 is a block diagram schematically illustrating a power transfer apparatus according to an embodiment;

FIG. 7 is a block diagram schematically illustrating a power receiver apparatus according to an embodiment; and

FIG. 8 is a diagram illustrating an example of arrangement of antennas in an antenna array according to an embodiment.

### DETAILED DESCRIPTION

According to one embodiment, a power receiver apparatus includes an antenna unit, a power reception circuit, a rectifier circuit, and a transmission circuit. The antenna unit includes, on a first face, one or more first antennas that receive radio waves from an outside, and two or more second antennas that transmit the radio waves to the outside. The power reception circuit is connected to the one or more first antennas, and receives a power signal via the one or more first antennas. The rectifier circuit rectifies the power signal that has been received by the power reception circuit. The transmission circuit is connected to the two or more second antennas, and transmits a wireless signal via the two or more second antennas. The first face of the antenna unit includes a first region, and a second region that is at least a portion of a region surrounding the first region, and the two or more second antennas are present in the second region.

Hereinafter, embodiments will be described with reference to the drawings. Note that a problem to be solved by the embodiments can be at least any one of the problems that correspond to the advantageous effects described in the description below as some non-restrictive examples, in addition to the above. Stated another way, a problem that corresponds to at least arbitrary one of the advantageous effects described in the description of the embodiments can be a problem to be solved by the embodiments.

### First Embodiment

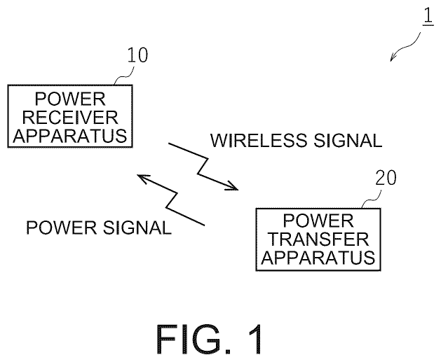

FIG. 1 is a diagram schematically illustrating a wireless power transfer system according to an embodiment. A wireless power transfer system 1 includes a power receiver apparatus 10 and a power transfer apparatus 20. The drawing illustrates one power receiver apparatus 10 and one power transfer apparatus 20, but this is not restrictive. In the wireless power transfer system 1, for example, one power transfer apparatus 20 may be included to correspond to a plurality of power receiver apparatuses 10, a plurality of power transfer apparatuses 20 may be included to correspond to one power receiver apparatus 10, or a plurality of power transfer apparatuses 20 may be included to correspond to a plurality of power receiver apparatuses 10.

The wireless power transfer system 1 is a system configured to charge the power receiver apparatus 10. The wireless power transfer system 1 transmits a power signal from the power transfer apparatus 20 to the power receiver apparatus 10 to supply power in a state where the power receiver apparatus 10 and the power transfer apparatus 20 are not in contact with each other. This is not restrictive, and the wireless power transfer system 1 can operate as a system that supplies power to an electronic device that includes the power receiver apparatus 10 or an electronic device that is connected to the power receiver apparatus 10.

The power receiver apparatus 10 transmits a wireless signal to the power transfer apparatus 20. The power transfer apparatus 20 receives the wireless signal that has been transmitted from the power receiver apparatus 10 to estimate a position of the power receiver apparatus 10, and transmits a power signal toward the position of the power receiver apparatus 10.

Furthermore, a wireless signal may be broadcasted from the power transfer apparatus 20. In this case, after determining, based on the reception of the wireless signal as a trigger, that it is located within a range where power can be supplied, the power receiver apparatus 10 may transmit a wireless signal to cause the power transfer apparatus 20 to initiate power supply.

More specifically, in the present disclosure, the power transfer apparatus 20 estimates an appropriate position in a power reception antenna or a power reception antenna array that is disposed in the power receiver apparatus 10 on the basis of the wireless signal that has been output from the power receiver apparatus 10, and outputs a power signal toward the estimated position. Specific implementation for performing this operation will be described.

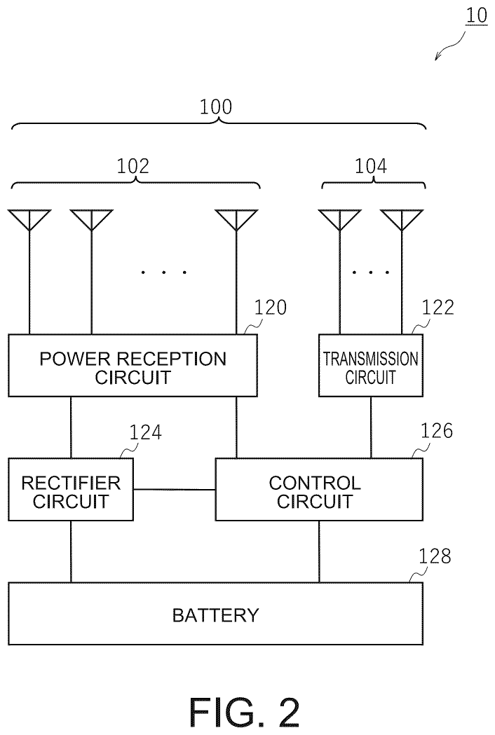

FIG. 2 is a block diagram schematically illustrating an example of the power receiver apparatus 10 according to an embodiment. The power receiver apparatus 10 includes, for example, an antenna unit (an antenna array 100) that includes antennas on a first face, a power reception circuit 120, a transmission circuit 122, a rectifier circuit 124, a control circuit 126, and a battery 128. The power receiver apparatus 10 is a device that receives a power signal via an antenna included in the antenna array 100, and supplies power to the battery 128.

The antenna array 100 is formed by arranging, in an array, a plurality of antennas that transmits or receives radio waves in the power receiver apparatus 10. Detailed arrangement will be described later. The antenna array 100 includes the first face, and includes a first antenna 102 and a second antenna 104 that are formed on the first face.

One or more first antennas 102 are included in the power receiver apparatus 10. The first antenna 102 is an antenna that receives radio waves, and the power receiver apparatus 10 receives, via the first antenna 102, a power signal that has been supplied from the outside. Although a plurality of first antennas 102 is illustrated, a configuration in which at least one first antenna 102 is included may be employed.

Two or more second antennas 104 are included in the power receiver apparatus 10. The second antenna 104 is an antenna that transmits radio waves, and the power receiver apparatus 10 transmits a wireless signal via the second antenna 104.

The power reception circuit 120 receives at least a power signal from the outside of the power receiver apparatus 10 via the first antenna 102. Furthermore, the power reception circuit 120 has been described as a circuit that receives a power signal, but the power reception circuit 120 may be configured to receive a data signal in addition to the power signal. A frequency band, communication standards, or the like of the power signal to be received is not limited to a specified type, and a form or means that is capable of appropriately supplying power (receiving a data signal) can be employed.

The transmission circuit 122 transmits a wireless signal to the outside of the power receiver apparatus 10 via the second antenna 104. A frequency band, communication standards, or the like of the wireless signal to be transmitted is not limited to a specified type. The wireless signal may be, as a non-restrictive example, a beacon signal that reports the presence of a power reception side wireless power transfer apparatus (the power receiver apparatus 10). Furthermore, the wireless signal may include at least one of information relating to a power signal transmission request, identifier information of the power reception side wireless power transfer apparatus (the power receiver apparatus 10), and positional information of each of the second antennas 104.

The transmission circuit 122 may add positional information of each of the second antennas 104 to a signal to be transmitted from a corresponding second antenna 104, and may transmit the wireless signal. Furthermore, the transmission circuit 122 may add positional information that corresponds to each of the plurality of second antennas 104, and may transmit the wireless signal from at least one of the plurality of second antennas 104. In this case, the transmission circuit 122 can transmit identification information and positional information of each of the second antennas 104 in association with each other.

This positional information may be global positional information, local positional information, or positional information relative to a reference point in the power receiver apparatus 10 or the antenna array 100.

The local positional information may be, for example, a position relative to a reference point in a space where the power transfer apparatus 20 is present. The reference point in the power receiver apparatus 10 or the antenna array 100 may be, for example, a position relative to a central point of the antenna array 100 (one or more first antennas 102 that are arranged) or a position relative to a reference point in a coordinate system including the antenna array 100.

As described above, the positional information is not obtained by any limited kind of means, but can be obtained by arbitrary means, for example, global means such as the GPS with high accuracy, means for obtaining the positional information from wireless information, such as Wi-Fi, or means based on information relating to mounting arrangement or the like of antennas in the power receiver apparatus 10.

The transmission circuit 122 may transmit the wireless signal from the respective second antennas 104 at different timings, that is, in a time-division manner. By transmitting the wireless signal from the respective power receiver apparatuses 10 and/or the respective second antennas 104 at different timings, when the power transfer apparatus 20 receives the wireless signal, the wireless signal can be identified as an independent signal from each of the antennas without combining a plurality of wireless signals.

The rectifier circuit 124 performs AC-DC conversion on the power signal received by the power reception circuit 120, and outputs the converted signal. The rectifier circuit 124 may be, as a non-restrictive example, a bridge rectifier circuit including a full bridge circuit, a half bridge circuit, and the like, but configurations other than these circuits are not excluded. The rectifier circuit 124 rectifies the power signal, and stores power in the battery 128.

The control circuit 126 controls the power reception circuit 120, the transmission circuit 122, and the rectifier circuit 124. The battery 128 may include, for example, a general-purpose processor, a hardware circuit such as an application specified integrated circuit (ASIC), a field programmable gate array (FPGA), or a programmable logic device (PLD), or a storage circuit. For example, in a case where the power reception circuit 120 has received, via the antenna array 100, a control signal including information relating to a request to transmit the wireless signal, the control circuit 126 can control the transmission circuit 122 to transmit the wireless signal via the second antenna 104. The control circuit 126 can also control or monitor, for example, charging or discharging of the battery 128. Information relating to control or monitoring can also be stored in a not-illustrated storage circuit.

Note that, in a case where a general-purpose circuit is used as the control circuit 126, data relating to software for specifically achieving information processing to be performed by the software, by using the control circuit 126 serving as a hardware resource can be stored in the not-illustrated storage circuit described above.

The battery 128 is a battery serving as a target to be supplied with power by the power receiver apparatus 10. The battery 128 is, for example, a secondary battery represented by a lithium ion battery, a lead-acid battery, a nickel hydrogen battery, or the like. The battery 128 may be another battery that is capable of achieving appropriate power transfer.

Furthermore, in FIG. 2, the battery 128 is illustrated as a structure provided inside the power receiver apparatus 10, but this is not restrictive. The battery 128 may be, for example, a single battery that is connected to the power receiver apparatus 10. Alternatively, the battery 128 may be, for example, a battery that is disposed inside an electronic device including the power receiver apparatus 10. The battery 128 may be a battery that supplies power for use in the operation of the power receiver apparatus 10 or the operation of the electronic device including the power receiver apparatus 10.

Next, the arrangement of antennas in the antenna array 100 will be described with reference to some drawings.

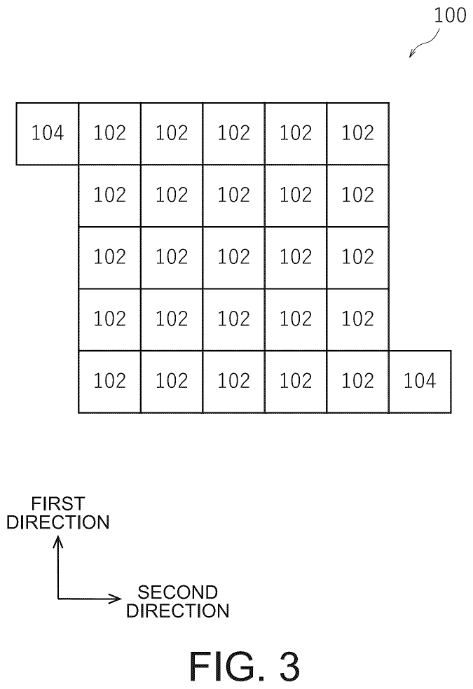

FIGS. 3, 4, and 5 are diagrams illustrating some non-restrictive examples of arrangement of the first antennas 102 and the second antennas 104 in the antenna array 100 according to an embodiment. The first antennas 102 that receive a power signal are arranged in an array, for example, in a first direction and a second direction that intersects the first direction. By employing this arrangement, a radiated power signal can be received over the entirety of the first face, and power supplied by the power signal can be efficiently obtained. Furthermore, the second antennas 104 are not arranged in a position where a power signal can be efficiently received, and this can further improve the efficiency of supplying power.

As illustrated, the first antennas 102 are arranged to occupy the vicinity of the center of the array. More specifically, in a region in the vicinity of the center of antenna array 100, the first antennas 102 are arranged in such a way that the first antennas 102 can appropriately receive radio waves. In other words, the second antennas 104 are not arranged in a position close to the center of the antenna array 100.

Stated another way, the antenna array 100 is included on the first face of the antenna unit, and includes a first region, and a second region that is at least a portion of a region that surrounds the first region. The first antennas 102 are arranged in the first region. The second antennas 104 are arranged in the second region. In FIGS. 3, 4, and 5, a region where the first antennas 102 are provided is the first region, and a region where the second antennas 104 are provided is the second region.

Furthermore, a distance between the second antenna 104 and the center of the antenna array 100 is longer than a distance between at least one first antenna 102 and the center of the antenna array 100. It is desirable that the distance between the second antenna 104 and the center of the antenna array 100 be longer than distances between all of the first antennas 102 and the center of the antenna array 100, as illustrated in FIGS. 3 to 5, but this is not restrictive. The distance between the second antenna 104 and the center of the antenna array 100 may be shorter than distances between some of the first antennas 102 and the center of the antenna array 100, as long as arrangement enables power to be appropriately received.

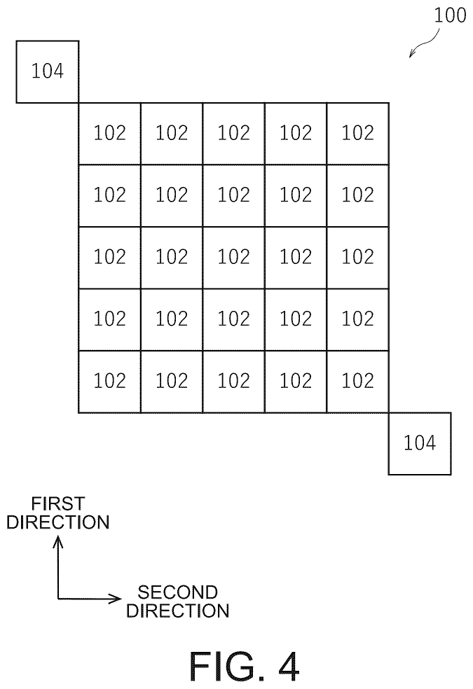

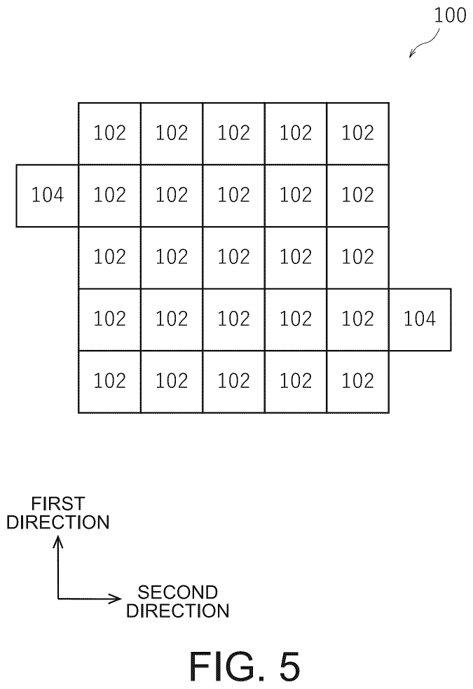

It is preferable that the second antennas 104 be arranged in positions farthest from the center of the array, as illustrated in FIG. 3 or 4. On the other hand, this is not restrictive, and as illustrated in FIG. 5, a mode in which the second antennas 104 are arranged in positions away from a position close to the center of the array can be employed in such a way that the first antennas 102 are arranged in the vicinity of the center of the array. It is preferable that the second antennas 104 be arranged symmetrically with a position of the center (a position close to the center) of the array as a center.

The transmission circuit 122 transmits a wireless signal via the plural arranged second antennas 104 at a timing that changes for each of the plural arranged second antennas 104 (in a time-division manner). The power transfer apparatus 20 receives the wireless signals from the second antennas 104, and estimates the position of the center of the array by using these wireless signals. The power transfer apparatus 20 transmits a power signal toward an estimated center position of the antenna array 100 or a position close to the center, and this enables power to be supplied to the power receiver apparatus 10 with high power efficiency.

Furthermore, the transmission circuit 122 may transmit, via the second antenna 104, a wireless signal including information indicating a position in the array of the second antenna 104. The transmission circuit 122 can transmit, for example, data for each of the second antennas 104 that indicates a position of a corresponding second antenna 104, on the wireless signal. The power transfer apparatus 20 can estimate the position of the center or the position close to the center of the antenna array 100 on the basis of not only information relating to a status of receiving radio waves in the wireless signal obtained from the second antenna 104 but also information indicating the position of the second antenna 104 included in the wireless signal.

Note that the second antennas 104 are arranged by using, as a reference, the array of the first antennas 102 that are arranged in 5×5, but a mode according to the present disclosure is not limited to this. For example, the number of first antennas 102 that form the array may be a smaller number, such as 1×1 or 2×2, may be a larger number, such as 6×6, or may be a number that does not form a square, such as 2×3 or 5×7. Moreover, the shape does not need to be a rectangle, and may be an arbitrary shape that can efficiently receive a power signal radiated toward the vicinity of the center of the array, such as a circle or an ellipse.

Furthermore, a mode in which the number of second antennas 104 is two has been described, but this is not restrictive. The number of second antennas 104 may be three or more, and it is sufficient if the second antennas 104 are arranged not to be present in a position close to the center of the array, similarly to the above. In this case, it is desirable that the second antennas 104 be arranged symmetrically relative to the center of the array, as described above. However, this is not restrictive, and any type of arrangement may be employed if a position of the center (a position in the vicinity of the center) can be appropriately estimated by using wireless signals transmitted from the plurality of second antennas 104.

As described above, according to the present embodiment, data for causing a power signal to be transmitted to an appropriate position in the antenna array 100 in the power receiver apparatus 10, can be transmitted. Furthermore, by setting the positions of the second antennas 104 to positions away from a position close to the center of the antenna array 100, one or more first antennas 102 can efficiently receive a beam of a power signal that has been transmitted toward an appropriate position (ideally, the position of the center of the antenna array 100).

In general, the intensity of power in a transmitted beam is the highest in a target position to which the beam is to be transmitted, and the intensity decreases toward the periphery. As described in the present embodiment, the first antenna 102 for power reception is arranged in a position close to the center, that is, a target position to which the beam is to be transmitted, and moreover, the plurality of first antennas 102 for power reception is arranged, and the second antenna 104 for transmission is not arranged in a position where power in the beam is strong. Therefore, power can be efficiently supplied by using a power signal, and stated another way, large power as a whole can be received.

Such beam transmission will be described in the following embodiment.

### Second Embodiment

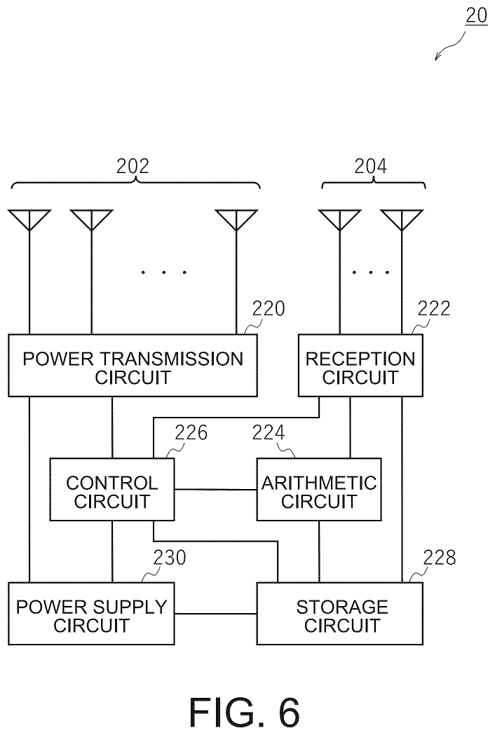

FIG. 6 is a block diagram schematically illustrating an example of a power transfer apparatus 20 according to an embodiment. The power transfer apparatus 20 includes, for example, a third antenna 202, a fourth antenna 204, a power transmission circuit 220, a reception circuit 222, an arithmetic circuit 224, a control circuit 226, a storage circuit 228, and a power supply circuit 230. The power transfer apparatus 20 receives, via the fourth antenna 204, the wireless signal transmitted from the power receiver apparatus 10 according to the first embodiment, and radiates a power signal to an appropriate position via the third antenna 202.

The third antenna 202 is an antenna that outputs a signal for causing the power transfer apparatus 20 to supply power. It is desirable that a plurality of third antennas 202 be included. The power transmission circuit 220 outputs a power signal to be used to supply power, via the third antenna 202 to the outside, for example, a position close to the center of the antennas of the power receiver apparatus 10. By using a plurality of third antennas 202, the power transfer apparatus 20 can achieve transmission of a power signal in a desired transmission direction by using, for example, a beamforming technique. Furthermore, the power transfer apparatus 20 does not necessarily use the beamforming technique, and can also transmit a power signal by mechanically moving a beam.

The fourth antenna 204 is an antenna that receives a signal from the outside in the power transfer apparatus 20. One or more fourth antennas 204 are included. The reception circuit 222 receives, via the fourth antenna 204, a signal from the outside, for example, a wireless signal that has been transmitted from the power receiver apparatus 10. The received signal may be a beacon signal, but is not limited to this.

The power transmission circuit 220 transmits a power signal via the plurality of third antennas 202. The power transmission circuit 220 outputs the power signal in an appropriate direction or toward an appropriate position on the basis of, for example, the beamforming technique or a mechanical technique.

The reception circuit 222 receives a wireless signal via one or more fourth antennas 204. The reception circuit 222 receives, for example, a plurality of wireless signals in a time-division manner. The reception circuit 222 outputs, to the arithmetic circuit 224, data relating to the plurality of wireless signals that has been received.

The arithmetic circuit 224 estimates information relating to a position of the center or a position close to the center in the antenna array 100 of the power receiver apparatus 10 on the basis of the wireless signal received by the reception circuit 222. For example, the arithmetic circuit 224 estimates a direction of arrival for each of a plurality of wireless signals transmitted via the plurality of second antennas 104. In a case where the transmission circuit 122 has transmitted wireless signals from the respective second antennas 104 at different timings, the reception circuit 222 receives the wireless signals at different timings, and therefore the arithmetic circuit 224 can obtain information relating to a signal that has been transmitted via each of the second antennas 104.

The arithmetic circuit 224 can obtain a direction of arrival of a signal that has been output via each of the second antennas 104. The arithmetic circuit 224 can estimate the position of the center or the position close to the center in the antenna array 100 on the basis of directions of arrival of the wireless signals obtained from the plurality of second antennas 104. In this case, the storage circuit 228 may store, in advance, data relating to a position of each of the second antennas 104, and the arithmetic circuit 224 can estimate the position of the center or the position close to the center on the basis of, for example, data indicating the position of each of the second antennas 104 that has been stored in the storage circuit 228.

Also in the description below, the expression “position close to the center” (or “position in the vicinity of the center”) is used, and this expression may be replaced with a position of the center of the antenna array 100 that has been estimated by the arithmetic circuit 224 or a position of transmission of a power signal (a power transfer signal) relative to the estimated position of the center. The phrase “position of transmission of the power signal” can be read according to the context as meaning including any one or both of a position to which the power transfer apparatus 20 is scheduled to transmit the power signal and a position of arrival in the antenna array 100 of the power receiver apparatus 10 of a power signal that has actually been transmitted by the power transfer apparatus 20.

Moreover, in a case where the wireless signal that has been transmitted from the power receiver apparatus 10 includes data indicating positional information of the second antenna 104, the arithmetic circuit 224 can obtain a position of each of the second antennas 104 by using this positional information. By obtaining the positional information, the arithmetic circuit 224 can estimate the position of the center or the position close to the center of the antenna array 100 in more detail on the basis of a direction of arrival of the wireless signal transmitted via each of the second antennas 104 and the positional information of each of the second antennas 104 in the antenna array 100. Of course, also in this case, the arithmetic circuit 224 may use data relating to the positions of the second antennas 104 that has been stored in the storage circuit 228.

The arithmetic circuit 224 may further estimate a position of the first antenna 102 that is arranged in a position closest to the center in antenna array 100 on the basis of the estimation above. In a case where the second antennas 104 are symmetrically arranged in the antenna array 100, the arithmetic circuit 224 can determine an estimated position that is the center of the directions of arrival of the wireless signals to be a position close to the center of the plurality of first antennas 102, and this makes it easy to perform an arithmetic operation to estimate the position close to the center in the antenna array 100.

The arithmetic circuit 224 determines the power transmission center on the basis of the wireless signals transmitted from the two or more antennas. For example, one power transmission center is present.

In a case where the second antennas 104 are arranged symmetrically relative to the center of the first region where the first antennas 102 are provided, the power transmission center is the center of the second antennas 104. Alternatively, in a case where the arithmetic circuit 224 has obtained, in advance, a relationship between the second antennas 104 and the center of the first region, the power transmission center is determined on the basis of this relationship.

Examples of the arithmetic circuit 224 include the beam former method, the Capon method, the linear prediction method, the multiple signal classification (MUSIC) method, the estimation of signal parameters via rotational invariance techniques (ESPRIT) method, and the like, but these methods are not restrictive, and an arbitrary method that enables a position to be appropriately obtained can be used.

The arithmetic circuit 224 outputs, to the control circuit 226, information relating to the position of the center or the position close to the center of the antenna array 100 that has been estimated.

The control circuit 226 controls components of the power transfer apparatus 20. The control circuit 226 may include, for example, a general-purpose processor, a hardware circuit such as an ASIC, an FPGA, or a PLD, or a storage circuit. The control circuit 226 can control, for example, a phase, an amplitude, or the like of the power signal, and an orientation or the like of the third antenna 202. The control circuit 226 can perform control to transmit a power signal by using, as a target, the position estimated by the arithmetic circuit 224.

Moreover, for example, in a case where the wireless signal includes information relating to a power signal transmission request and information relating to an identifier or the like of the power receiver apparatus 10, the control circuit 226 can perform control to cause the power transmission circuit 220 to transmit a power signal to a power receiver apparatus 10 that corresponds to the information relating to the identifier or the like. In a case where a plurality of power receiver apparatuses 10 is present, the control circuit 226 can perform control to transmit a power signal to an appropriate power receiver apparatus 10, in accordance with a preset algorithm or in accordance with a predetermined processing flow.

In a case where a plurality of third antennas 202 is present, a variable phase circuit can be provided in each of the third antennas 202 or before and after an interface that connects the power transmission circuit 220 to each of the third antennas 202. The variable phase circuit may be provided for some of the third antennas 202, or may be provided for all of the third antennas 202. The power transmission circuit 220 can transmit a power signal to a position closest to the center of the antenna array 100 that has been estimated by the arithmetic circuit 224 at a phase of the variable phase circuit controlled by the control circuit 226.

For example, a mechanism for mechanically changing an orientation of the third antenna 202 by using a motor or the like may be included. The power transmission circuit 220 can transmit a power signal to a position closest to the center of the antenna array 100 that has been estimated by the arithmetic circuit 224, according to the orientation of the third antenna 202 that has been controlled by the control circuit 226.

The storage circuit 228 provides a storage area where various types of data can be stored. The storage circuit 228 may be, for example, any of a volatile memory and a nonvolatile memory, and may be a storage device such as a hard disk, or an external storage device, and the type of the storage circuit 228 is not particularly limited. The storage circuit 228 may have a mode in which data, such as an identifier of each of the power receiver apparatuses 10 or a position of the second antenna 104 in each of the power receiver apparatuses 10, has been stored in advance. In addition, in a case where information processing to be performed by software is achieved by at least some circuits in the power transfer apparatus 20 serving as hardware resources, information relating to the software can be stored.

The power supply circuit 230 supplies power to other components of the power transfer apparatus 20. The power supply circuit 230 may perform conversion for supplying power to other components of the power transfer apparatus 20. The power supply circuit 230 may include a configuration that achieves step-up or step-down by using, for example, a DC-DC converter. In addition, the power supplied from the power supply circuit 230 enables the power transmission circuit 220 to obtain power to be used to supply power wirelessly via the third antenna 202.

As described above, by employing the power transfer apparatus 20 according to the present embodiment, it is possible to transmit an appropriate power signal based on data obtained from the power receiver apparatus 10 according to the embodiment described above. Stated another way, in a case where the power receiver apparatus 10 according to the first embodiment is used, as a non-restrictive example, the power transfer apparatus 20 according to the present embodiment can operate as a power transfer apparatus configured to efficiently supply power. Stated another way, the power transfer apparatus 20 according to the present embodiment can supply high power.

Note that the configuration described in the present embodiment has been described as an example, and other configurations are not excluded for a power transfer apparatus of a power receiver apparatus 10 according to the embodiment described above or other embodiments. Furthermore, the power transfer apparatus 20 according to the present embodiment can operate similarly for a power receiver apparatus 10 according to the embodiment described below, and can exhibit similar advantageous effects.

### Third Embodiment

In the embodiment described above, the power receiver apparatus 10 includes the first antenna 102 and the second antenna 104 as antennas, and the second antenna 104 is a transmission antenna. However, this mode is not restrictive. For example, the second antenna 104 can be further used as a reception antenna.

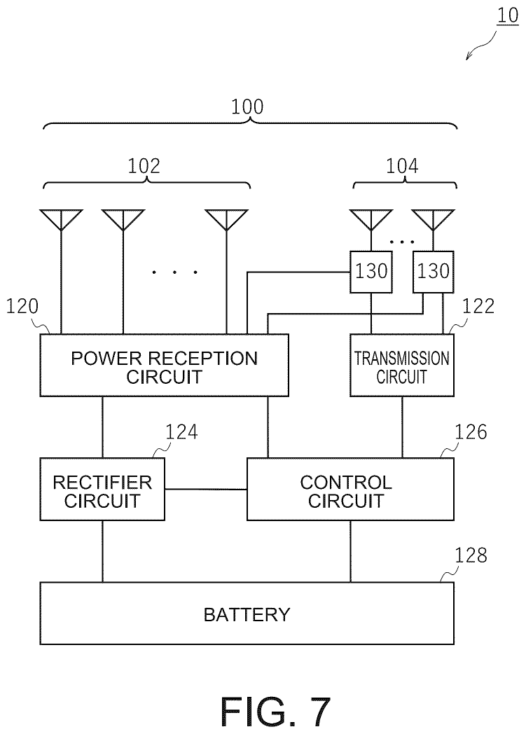

FIG. 7 is a block diagram schematically illustrating a power receiver apparatus according to an embodiment. A power receiver apparatus 10 can include a switch 130 in addition to the configuration of the embodiment described above.

The switch 130 is provided between the second antenna 104 and the transmission circuit 122. The switch 130 is also connected to the power reception circuit 120. The switch 130 can switch whether the second antenna 104 is connected to the transmission circuit 122 or the power reception circuit 120. Stated another way, by employing the configuration of the switch 130, the second antenna 104 is used for both reception of a power signal and transmission of a wireless signal.

The switch 130 switches a connection destination, and therefore at a timing when the power receiver apparatus 10 transmits a wireless signal, the second antenna 104 is connected to the transmission circuit 122, and functions as a transmission antenna, and at a timing when the power receiver apparatus 10 receives a power signal, the second antenna 104 is connected to the power reception circuit 120, and functions as a reception antenna.

The antenna array 100 can have a configuration that is similar to that of the embodiment described above, and even if the antenna array 100 has another configuration, as described below, the antenna array 100 can efficiently achieve power reception similarly.

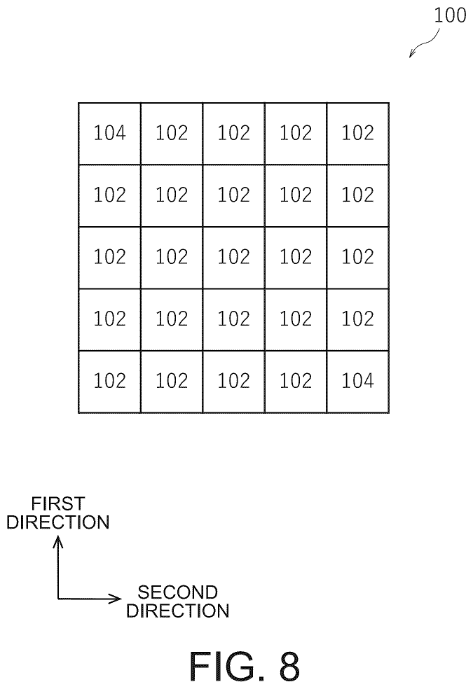

FIG. 8 is a diagram illustrating an example of arrangement of antennas in an antenna array according to an embodiment. As illustrated in this drawing, preferably, the second antennas 104 that are used for both reception and transmission can be arranged, for example, in diagonal positions in two-dimensional array arrangement in the first direction and the second direction. In FIG. 8, a region where the first antennas 102 are provided is a first region, and a region where the second antennas 104 are provided is a second region.

Preferably, the second antennas 104 can also be arranged in positions that are farthest from a position close to the center in the antenna array 100 (the illustrated diagonal positions). By employing this arrangement, the power receiver apparatus 10 can receive power over the entire array of the antenna array 100, the second antennas 104 can be arranged in positions where an influence on power reception of a power signal radiated toward a position close to the center of the antenna array 100 is the smallest in the antenna array 100, and an influence of a power loss caused by the switch 130 can be reduced.

For example, in a case where one second antenna 104 is present in a mode in which the switch 130 is included, it is possible to transmit positional information to the power transfer apparatus 20 by providing the second antenna 104 in the position of the center of the antenna array 100. However, in this configuration, a loss caused by the switch 130 occurs in an antenna in a position where the intensity of power is the strongest, and this can result in a large loss. According to the present embodiment, such a large loss can be prevented from occurring, and larger power can be supplied.

The contents of the present disclosure can also be summarized as follows.

(1) A power receiver apparatus comprising:
an antenna unit that includes, on a first face, one or more first antennas that receive radio waves from an outside, and two or more second antennas that transmit the radio waves to the outside;
a power reception circuit that is connected to the one or more first antennas, and receives a power signal via the one or more first antennas;
a rectifier circuit that rectifies the power signal that has been received by the power reception circuit; and
a transmission circuit that is connected to the two or more second antennas, and transmits a wireless signal via the two or more second antennas, wherein the first face of the antenna unit includes a first region, and a second region that is at least a portion of a region surrounding the first region, and the two or more second antennas are present in the second region.

(2) The power receiver apparatus according to (1), wherein the radio waves from the outside are a signal that has been transmitted based on the wireless signal.

(3) The power receiver apparatus according to (1) or (2), wherein the wireless signal is a beacon signal.

(4) The power receiver apparatus according to any one of (1) to (3), wherein the transmission circuit transmits the wireless signal from each of the two or more second antennas at a different timing.

(5) The power receiver apparatus according to any one of (1) to (4), wherein the transmission circuit transmits the wireless signal including positional information relating to each of the two or more second antennas.

(6) The power receiver apparatus according to any one of (1) to (5), wherein the two or more second antennas are arranged symmetrically relative to a center of an antenna array in which the one or more first antennas are included.

(7) The power receiver apparatus according to any one of (1) to (6), further comprising a switch that is connected between the two or more second antennas and the transmission circuit, wherein the switch is further connected to the power reception circuit.

(8) The power receiver apparatus according to (7), wherein the switch performs:

connecting the two or more second antennas to the transmission circuit at a timing when the transmission circuit transmits the wireless signal; and connecting the two or more second antennas and the power reception circuit at a timing when the power reception circuit receives the power signal.

(9) The power receiver apparatus according to any one of (1) to (8), wherein a distance between each of the two or more second antennas and a center of an antenna array is longer than a distance between each of the one or more first antennas and the center of the antenna array.

(10) A power transfer apparatus comprising:
one or more antennas;
a power transmission circuit that is connected to at least one of the one or more antennas, and transmits a power signal to a power transmission center via the at least one of the one or more antennas;
a reception circuit that is connected to at least one of the one or more antennas, and receives a wireless signal via the at least one of the one or more antennas; and
an arithmetic circuit that determines the power transmission center based on the wireless signal that has been transmitted from two or more antennas, wherein
the power transmission circuit performs control to transmit the power signal to a position close to the power transmission center that has been estimated by the arithmetic circuit.

(11) A wireless power transfer system comprising:
the power receiver apparatus according to any one of (1) to (9); and
the power transfer apparatus according to (10), wherein
the power receiver apparatus transmits the radio signal via the second antenna, and the power transfer apparatus transmits the power signal based on information on the radio signal transmitted by the power receiver apparatus.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A power receiver apparatus comprising:
an antenna unit that includes, on a first face, one or more first antennas that receive radio waves from an outside, and two or more second antennas that transmit the radio waves to the outside;
a power reception circuit that is connected to the one or more first antennas, and receives a power signal via the one or more first antennas;
a rectifier circuit that rectifies the power signal that has been received by the power reception circuit; and
a transmission circuit that is connected to the two or more second antennas, and transmits a wireless signal via the two or more second antennas, wherein
the first face of the antenna unit includes a first region, and a second region that is at least a portion of a region surrounding the first region, and the two or more second antennas are present in the second region.

2. The power receiver apparatus according to claim 1, wherein the radio waves from the outside are a signal that has been transmitted based on the wireless signal.

3. The power receiver apparatus according to claim 1, wherein the wireless signal is a beacon signal.

4. The power receiver apparatus according to claim 1, wherein the transmission circuit transmits the wireless signal from each of the two or more second antennas at a different timing.

5. The power receiver apparatus according to claim 1, wherein the transmission circuit transmits the wireless signal including positional information relating to each of the two or more second antennas.

6. The power receiver apparatus according to claim 1, wherein the two or more second antennas are arranged symmetrically relative to a center of an antenna array in which the one or more first antennas are included.

7. The power receiver apparatus according to claim 1, further comprising
a switch that is connected between the two or more second antennas and the transmission circuit, wherein
the switch is further connected to the power reception circuit.

8. The power receiver apparatus according to claim 7, wherein
the switch performs:
connecting the two or more second antennas to the transmission circuit at a timing when the transmission circuit transmits the wireless signal; and
connecting the two or more second antennas and the power reception circuit at a timing when the power reception circuit receives the power signal.

9. The power receiver apparatus according to claim 1, wherein
a distance between each of the two or more second antennas and a center of an antenna array is longer than a distance between each of the one or more first antennas and the center of the antenna array.

10. A power transfer apparatus comprising:
one or more antennas;
a power transmission circuit that is connected to at least one of the one or more antennas, and transmits a power signal to a power transmission center via the at least one of the one or more antennas;
a reception circuit that is connected to at least one of the one or more antennas, and receives a wireless signal via the at least one of the one or more antennas; and
an arithmetic circuit that determines the power transmission center based on the wireless signal that has been transmitted from two or more antennas, wherein
the power transmission circuit performs control to transmit the power signal to a position close to the power transmission center that has been estimated by the arithmetic circuit.

11. A wireless power transfer system comprising:
a power receiver apparatus having:
an antenna unit that includes, on a first face, one or more first antennas that receive radio waves from an outside, and two or more second antennas that transmit the radio waves to the outside;
a power reception circuit that is connected to the one or more first antennas, and receives a power signal via the one or more first antennas;
a rectifier circuit that rectifies the power signal that has been received by the power reception circuit; and
a transmission circuit that is connected to the two or more second antennas, and transmits a wireless signal via the two or more second antennas; and
a power transfer apparatus having:
one or more antennas;
a power transmission circuit that is connected to at least one of the one or more antennas, and transmits a power signal to a power transmission center via the at least one of the one or more antennas;
a reception circuit that is connected to at least one of the one or more antennas, and receives a wireless signal via the at least one of the one or more antennas; and
an arithmetic circuit that determines the power transmission center based on the wireless signal that has been transmitted from two or more antennas, wherein
the first face of the antenna unit includes a first region, and a second region that is at least a portion of a region surrounding the first region, and the two or more second antennas are present in the second region, and the power transmission circuit performs control to transmit the power signal to a position close to the power transmission center that has been estimated by the arithmetic circuit, and wherein
the power receiver apparatus transmits the wireless signal via the second antennas and the power transfer apparatus transmits the power signal based on the wireless signal transmitted by the transmission circuit.
